(19) United States
(12) Patent Application Publication
(10) Pub. No.: US 2020/0015012 A1
(43) Pub. Date: Jan. 9, 2020

(54) Remote Audio Channel Isolation System

(71) Applicant: Uplift PTC, LLC, Austin, TX (US)

(72) Inventor: James W. Brilmayer, Houston, TX (US)

(21) Appl. No.: 16/027,939

(22) Filed: Jul. 5, 2018

(51) Int. Cl. H04R 5/04; H04R 5/02; H04S 3/00

(52) U.S. Cl. CPC H04R 5/04; H04R 5/02; H04S 2400/01; H04R 2420/07; H04S 3/008

(57) ABSTRACT

In one embodiment, the disclosure provides an audio system including a first power source, a first synchronous media transceiver, a first speaker unit, a second power source, a second synchronous media transceiver, a second speaker unit, a third power source, a third synchronous media transceiver, and a third speaker unit. The first, second, and third synchronous media transceivers are configured to receive audio data. The first, second, and third speaker units are configured to receive power from the respective power sources, receive one or more of a first and second audio channel of the received audio data from the first, second and third synchronous media transceivers, and actuate respective speakers to convert the audio channels into corresponding acoustic signals.

### BACKGROUND

The present disclosure relates to audio production. More particularly, the present disclosure relates to wireless audio systems having a plurality of speaker units.

### SUMMARY

In one embodiment, the disclosure provides an audio system including a first power source, a first synchronous media transceiver, a first speaker unit, a second power source, a second synchronous media transceiver, a second speaker unit, a third power source, a third synchronous media transceiver, and a third speaker unit. The first, second, and third synchronous media transceivers are configured to receive audio data. The first speaker unit is configured to receive power from the first power source, receive a first audio channel of the audio data from the first synchronous media transceiver, and actuate speaker to convert the first audio channel into a corresponding acoustic signal.

The second speaker unit is configured to receive power from the second power source, receive a second audio channel from the second synchronous media transceiver, and actuate a speaker to convert the second audio channel into a corresponding acoustic signal. The third speaker unit is configured to receive power form the third power source, receive the first audio channel and the second audio channel of the audio data from the third synchronous media transceiver, and actuate a speaker to convert the first audio channel and the second audio channel into a corresponding acoustic signal. In some embodiments, the first power source, the second power source, and the third power source are independent power sources.

In some embodiments, one or more of the first speaker unit, the second speaker unit, and the third speaker unit include one or more full-range drivers. In some embodiments, at least one of the first, second, and third synchronous media transceivers is configured to wirelessly receive the audio data. In some embodiments, at least one of the first power source, the second power source, and the third power source is a battery.

In some embodiments, the first speaker unit is configured to receive the second audio channel from the first synchronous media transceiver and selectively inhibit actuation of the speaker to prevent conversion of the second audio channel into a corresponding acoustic signal. In some embodiments, the second speaker unit is configured to receive the first audio channel of from the second synchronous media transceiver and selectively inhibit actuation of the speaker to prevent conversion of the first audio channel into a corresponding acoustic signal. In some embodiments, the first speaker unit includes an electronic circuit for selectively inhibiting the second audio channel. In some embodiments, the second speaker unit includes and electronic circuit for selectively inhibiting the first audio channel.

In some embodiments, the first power source, the first synchronous media transceiver, and the first speaker unit are retained in a common housing.

In some embodiments, the disclosure provides a method of managing a speaker system, including providing, to each of a first synchronous media transceiver, a second synchronous media transceiver, and a third synchronous media transceiver, respectively, a first power source, a second power source, and a third power source. The method further includes coupling each of a first speaker unit, a second speaker unit, and a third speaker unit, respectively, to the first power source, the second power source, and the third power source. The method further includes synchronizing the first synchronous media transceiver, the second synchronous media transceiver, and the third synchronous media transceiver with a source of audio data. The method further includes receiving the audio data by each of the first synchronous media transceiver, the second synchronous media transceiver, and the third synchronous media transceiver. The method further includes receiving a first audio channel of the audio data at the first speaker unit via the first synchronous media transceiver, receiving a second audio channel of the audio data at the second speaker unit via the second synchronous media transceiver, and receiving the first audio channel and the second audio channel at the third speaker unit via the third synchronous media transceiver. The method further includes actuation respective speakers of each of the first speaker unit, the second speaker unit, and the third speaker unit based on the synchronizing with the source, and the respectively received audio data.

In some embodiments, the first speaker unit, the second speaker unit, and the third speaker unit each include a full-range driver. In some embodiments, each of the first, second, and third synchronous media transceivers are configured to wirelessly receive the audio data. In some embodiments, at least one of the first power source, the second power source, and the third power source is a battery. In some embodiments, the method further includes receiving the second audio channel at the first speaker unit via the first synchronous media transceiver and receiving the first audio channel at the second speaker unit via the second synchronous media transceiver. In some embodiments, the method further includes selectively inhibiting transmission of the second audio channel at the first speaker unit, and selectively inhibiting transmission of the first audio channel at the second speaker unit.

In some embodiments, at least one of the first audio channel and the second audio channel is selectively inhibited with a dedicated electronic circuit. In some embodiments, the first power source, the first synchronous media transceiver, and the first speaker unit are retained in a common housing.

In some embodiments, the disclosure provides an audio system including a first speaker unit, a second speaker unit, and a third speaker unit. The first speaker unit includes a first housing, a first power source within the first housing, a first synchronous media transceiver retained in the first housing, a first speaker retained in the first housing, and electronic control circuitry. The first synchronous media transceiver is configured to receiver audio data including a first audio channel and a second audio channel. The electronic control circuitry of the first speaker unit is configured to receiver power from the first power source, receive the audio data from the first synchronous media transceiver, selectively inhibit the second audio channel, and actuate the first speaker to convert the first audio channel into a corresponding acoustic signal.

The second speaker unit includes a second housing, a second power source retained in the second housing, a second synchronous media transceiver retained in the second housing, a second speaker retained in the second housing, and electronic control circuitry. The second synchronous media transceiver is configured to receive audio data including the first audio channel and the second audio channel. The electronic control circuitry of the second speaker unit is configured to receive power from the second power source, receive the second audio channel of the audio data from the second synchronous media transceiver, selectively inhibit the first audio channel, and actuate the second speaker to convert the second audio channel into a corresponding acoustic signal.

The third speaker unit includes a third housing, a third synchronous media transceiver retained in the third housing, a third speaker retained in the third housing, and electronic control circuitry. The third synchronous media transceiver is configured to receive audio data including the first audio channel and the second audio channel. The electronic control circuitry of the third speaker unit is configured to receive power from a third power source, receive the first audio channel and the second audio channel of the audio data from the third synchronous media transceiver, and actuate the third speaker to convert the first audio channel and the second audio channel into a corresponding acoustic signal. In some embodiments, the first power source, the second power source, and the third power source are independent power sources.

In some embodiments, the first speaker unit, the second speaker unit, and the third speaker unit each include a full-range driver. In some embodiments, each of the first, second, and third synchronous media transceivers are configured to wirelessly receive the audio data. In some embodiments, at least one of the first power source, the second power source, and the third power source is a battery. In some embodiments, the electronic control circuitry of the first speaker unit and the electronic circuitry of the second speaker unit each include resistive circuitry for selectively inhibiting an audio channel. In some embodiments, the audio system further includes a fourth speaker unit.

Other aspects of the disclosure will become apparent by consideration of the detailed description and accompanying drawings.

### BRIEF DESCRIPTION OF THE DRAWINGS

FIG. 1 is a block diagram of a speaker unit, in accordance with some embodiments.

FIG. 2 is a block diagram of an audio source device, in accordance with some embodiments.

FIG. 3 illustrates an audio system, in accordance with some embodiments

FIG. 4 is a flow diagram of a method of managing a speaker system, in accordance with some embodiments.

FIG. 5 is a flow diagram of a method of managing a speaker system, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

The apparatus and method components have been represented where appropriate by conventional symbols in the drawings, showing only those specific details that are pertinent to understanding various embodiments so as not to obscure the disclosure with details that will be readily apparent to those of ordinary skill in the art having the benefit of the description herein.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

It should also be noted that a plurality of different structural components may be utilized to implement the disclosure. Furthermore, and as described in subsequent paragraphs, the specific configurations illustrated in the drawings are intended to exemplify certain embodiments. Alternative configurations are possible.

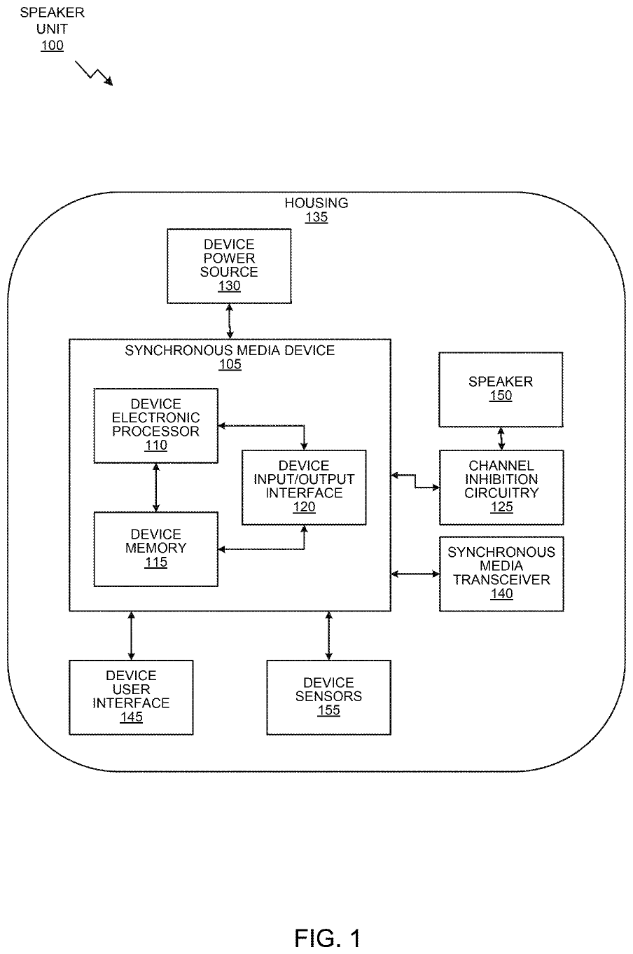

FIG. 1 illustrates a speaker unit 100, having a housing 135, and one or more actuating elements 150, such as a movable diaphragm or speaker 150. The speaker is controlled by a synchronous media device 105 to convert an audio signal into a corresponding acoustic signal.

The synchronous media device 105 includes, among other things, a device electronic processor 110 (for example, a microprocessor), a device memory 115, a device input/output interface 120, and a bus. The bus connects various components of the device electronic controller including the device memory 115 to the device electronic processor 110. The device memory 115 includes read only memory (ROM), random access memory (RAM), an electrically erasable programmable read-only memory (EEPROM), other non-transitory computer-readable media, or any combination thereof. The device electronic processor 110 is configured to retrieve program instructions and data from the device memory 115 and execute, among other things, instructions to perform the methods described herein. Additionally or alternatively, the device memory 115 is included in the device electronic processor 110. The device input/output interface 120 includes routines for transferring information between components within the device electronic processor 110 and other components internal and external to the synchronous media device 105. In some embodiments, the speaker unit 100 also includes, among other things, a plurality of passive and active components such as resistors, capacitors, inductors, integrated circuits, and amplifiers, such as channel inhibition circuitry 125. These components are arranged and connected to provide a plurality of electrical and acoustic functions to the speaker unit 100 including, among other things, filtering, signal conditioning, voltage regulation, or selective inhibition of one or more electrical signals, such as an audio channel. For example, selective inhibition of one or more electrical signals may be accomplished by connecting a signal line to a dump resistor or leaving a signal line open or “floating”. In one embodiment, selective inhibition is accomplished by connecting an input of a splitter circuit to an electronic signal line and connecting less than all of the outputs of the splitter circuit to downstream components. For example, splitter circuitry may include a single input and two outputs. In this embodiment, one of the outputs is selected to not be connected to a downstream component and is left open.

A device power source 130 supplies a nominal AC or DC voltage to the synchronous media device 105. In some embodiments, the device power source 130 supplies the nominal AC or DC voltage to additional devices within the speaker unit 100. In some embodiments, the device power source 130 is retained in the housing 135 of the speaker unit 100. In some embodiments, the synchronous media device 105 is retained in the housing 135 of the speaker unit 100. In some embodiments, the device power source 130 is powered by one or more batteries or battery packs included in the housing of the speaker unit 100 (for example, rechargeable batteries). Alternatively or in addition, the device power source 130 is powered by mains power having nominal line voltages between, for example, 100 volts AC and 240 volts AC and frequencies of approximately 50 hertz to 60 hertz. In some embodiments, the speaker unit 100 is coupleable to mains power to recharge the device power source 130. In some embodiments, the device power source 130 is configured to supply lower voltages to operate circuits and components within the speaker unit 100. Alternatively or in addition, the device electronic controller includes a power supply module (not shown) that converts the voltage received from the device power source 130 into lower voltages to operate circuits and components within the speaker unit 100.

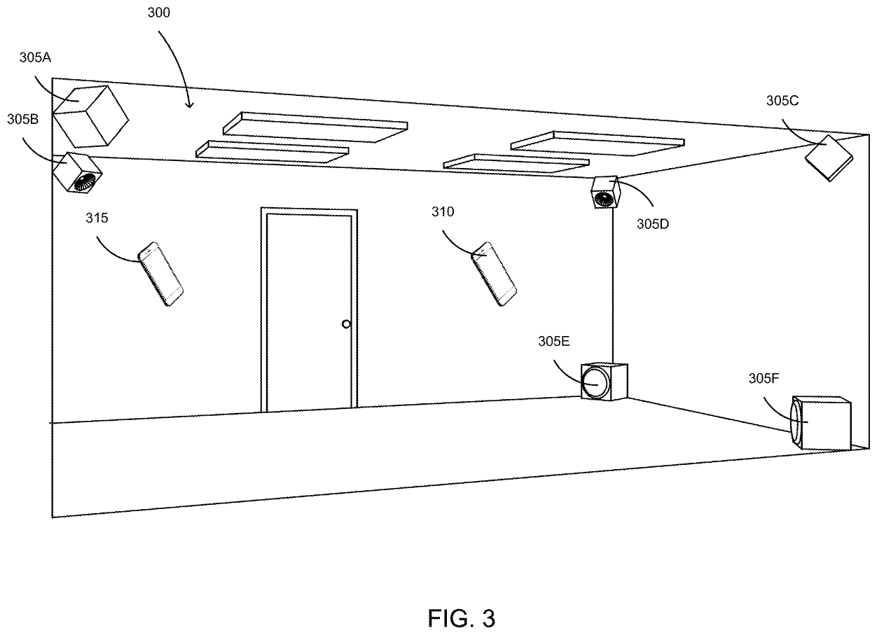

The synchronous media transceiver 140 is configured to provide communications between the speaker unit 100 and the source of audio data or other components within an audio system (for example, audio system 300 of FIG. 3). The synchronous media transceiver 140 transmits signals to one or more communication networks and receives signals from the communication networks. In some embodiments, signals include, for example, data, data packets, or any combination thereof. In some embodiments, the synchronous media transceiver 140 includes separate transmitters and receivers. The communication networks may be implements using various networks, for example, a cellular network, the Internet, a Bluetooth™ network, a wireless local area network (for example, Wi-Fi), a wireless accessory Personal Area Network (PAN), cable, an Ethernet network, satellite, a machine-to-machine (M2M) autonomous network, and a public switched telephone network.

The device user interface 145 is includes to control the operation of the speaker unit 100. The device user interface 145 can include any combination of digital and analog input devices required to achieve a desired level of control for the speaker unit 100. For example, the device user interface 145 can include a touch-screen display, a plurality of knobs, dials, switches, buttons, and the like. The device user interface 145 is operably coupled to the device electronic controller channel inhibition circuitry 125 to control, for example, the actuation of a speaker 150. In some embodiments, the device user interface 145 includes a push button that selectively inhibits one or more audio channels. For example, in the case that the synchronous media transceiver 140 receives audio data including a first audio channel and a second audio channel, responsive to the push button being selected by a user, the channel inhibition circuitry 125 prevents or inhibits transmission of one or more of the audio channels to the speaker 150, for example, by connecting an audio signal to a dump resistor.

In some embodiments, the device user interface 145 includes one or more indicators that indicate statuses of the speaker unit 100 (for example, visual indicators). For example, the device user interface 145 can include one or more light-emitting diodes (LEDs) that indicate when the speaker unit 100 is operating, when the push button has been selected, and when the device power source 130 is in need of a charge.

The plurality of device sensors 155 includes sensors for determining the location, the position, and the orientation of the speaker unit 100. For example, the plurality of device sensors 155 can include global positioning system (GPS) sensors, accelerometers, gyroscopes, magnetometers, distance sensors (for example, ultrasonic sensors), or a combination thereof.

In some embodiments, the device electronic processor 110 determines an absolute or relative location of the speaker unit 100 based on data received from one or more of the plurality of device sensors 155. Alternatively or in addition, the device electronic processor 110 determines an absolute or relative location of the speaker unit 100 based at least in part on one or more signals received via the synchronous media transceiver 140. For example, the device electronic processor 110 may determine the relative location of the speaker unit 100 to a source of audio data based on signals transmitted from the source of audio data.

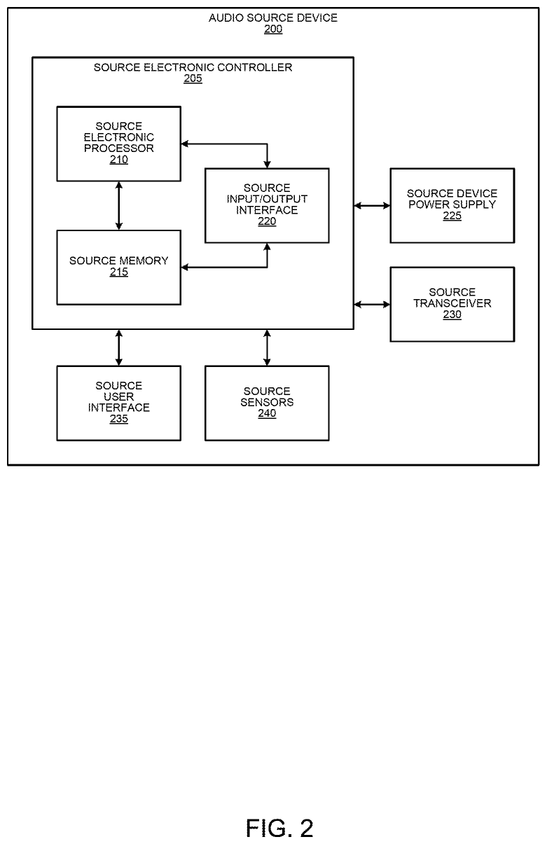

FIG. 2 is a block diagram of one example embodiment of the source device 200 of audio data. In the illustrated embodiment, the source device 200 includes a source electronic controller 205, a source power source, a source transceiver 230, a source user interface 235, and a plurality of source sensors. The source device 200 described herein may include fewer, additional, or different components in different configurations than the source device 310 illustrated in FIG. 3.

The source electronic controller 205 includes, among other things, a source electronic processor 210 (for example, a microprocessor), source memory 215, a source input/output interface 220, and a bus. The bus connects various components of the source electronic controller 205 including the source memory 215 to the source electronic processor 210. The source memory 215 includes read-only memory (ROM), random access memory (RAM), an electrically erasable programmable read-only memory (EEPROM), other non-transitory computer-readable media, or any combination thereof. The source electronic processor 210 is configured to retrieve program instructions and data from the source memory 215 and execute, among other things, instructions to perform the methods described herein. Additionally or alternatively, the source memory 215 is included in the source electronic processor 210. The source input/output interface 220 includes routines for transferring information between components within the source electronic controller 205 and other components internal and external to the source device 200. In some embodiments, the source electronic controller 205 also includes, among other things, a plurality of additional passive and active components such as resistors, capacitors, inductors, integrated circuits, and amplifiers. These components are arranged and connected to provide a plurality of electrical functions to the source electronic controller 205 including, among other things, filtering, signal conditioning, or voltage regulation.

The source device power supply 225 supplies a nominal AC or DC voltage to the source device 200. In some embodiments, the source device power supply 225 is powered by one or more batteries or battery packs included in the source device 200 (for example, rechargeable batteries). Alternatively or in addition, the source device power supply 225 is powered by mains power having nominal lines voltages between, for example, 100 volts AC and 240 volts AC and frequencies of approximately 50 hertz to 60 hertz. In some embodiments, the source device 200 is coupleable to mains power to recharge the source power source. In some embodiments, the source device power supply 225 is configured to supply lower voltages to operate circuits and components within the source device 200. Alternatively or in addition, the source electronic controller 205 includes a power supply module (not shown) that converts the voltage received from the source device power supply 225 into lower voltages to operate circuits and components within the source device 200.

The source transceiver 230 is configured to provide communications between the source device 200 and one or more speaker units (e.g. speaker unit 100) or other components within the audio system (for example, audio system 300 of FIG. 3). The source transceiver 230 transmits signals to one or more communication networks and receives signals from the communication networks. In some embodiments, signals include, for example, data, data packets, or any combination thereof. In some embodiments, the source transceiver 230 includes separate transmitters and receivers.

The source user interface 235 is included to control the source device 200 or the operation of one or more speaker units 100. The source user interface 235 is operably coupled to the source electronic controller 205 to control, for example, the selective inhibition of one or more audio signals at one or more speaker units 100 via the source transceiver 230. The source user interface 235 can include any combination of digital and analog input devices required to achieve a desired level of control for the system. For example, the source user interface 235 can include a touch-screen display, a plurality of knobs, dials, switches, buttons, and the like.

The plurality of source sensors 240 includes sensors for determining the environmental information about the source device 200, such as location or sound pressure level. For example, the plurality of source sensors 240 can include global positioning system (GPS) sensors. In some embodiments, the plurality of source sensors 240 includes sensors for detecting motion of the source device 200 (for example, accelerometers, gyroscopes, and magnetometers).

In some embodiments, the source device 200 acts as a remote control to enable the user to control the operation of one or more speaker units 100 within the audio system. For example, the source user interface 235 can include a touch-screen display which the user manipulates to control the operation of the speaker units 100.

Alternatively or in addition, the source device 200 acts as a tracking device to enable one or more speaker units 100 to track the location of the source device 200. In some embodiments, the source device 200 continuously or periodically determines its location via one or more of the source sensors 240 and sends its determined location to one or more of the speaker units 100 via the source transceiver 230. In such embodiments, the device electronic processor 110 can use the received location of the source device 200 to operate the speaker, for example, to modify an amplitude or delay of an audio signal. In some embodiments, the source transceiver 230 sends location signals to one or more speaker units 100. In such embodiments, the device electronic processor 110 determines a relative position of the speaker 100 unit to the source device 200 based on measured signal strengths of the location signals received via the synchronous media transceiver 140 and operates the speaker 150 such that sounds from a plurality of speaker units 100 are synchronously received at a region proximate the source device 200.

In some embodiments, the source device 200 acts as a tracking device to enable one or more speaker units 100 to follow the user of the source device 200. For example, in some embodiments, the source device 200 is incorporated in a wearable device, such as a smartwatch. Alternatively or in addition, the source device 200 is (or is included in) a portable electronic device, such as a smart phone or tablet. Alternatively, or in addition, the source device 200 and the tracking device may be separate devices. For example, the source device 200 may be home server or media transceiver and the tracking device may be a portable electronic device.

FIG. 3 is illustrates an audio system 300 installed in a room. The audio system includes a plurality of speaker units 305A-F configured substantially similar as speaker unit 100. For example, speaker units 305A-D are speaker units configured to operate on battery power, whereas speaker units 305E,F are configured to operate on mains power. The audio system further includes an audio source device 310, configured similarly to source device 200, such as a smartphone. Accordingly, the audio source device 310 is in communication with the speaker units 300 over one or more networks. The audio source device 310 communicates with synchronous media devices of the respective speaker units 100 to facilitate synchronization amongst the speaker units 305 of the audio system 300. For example, the speaker units 305 may be synchronized to produce an acoustic signal substantially simultaneously. Alternatively, the speaker units 305 may be synchronized to produce an acoustic signal with an intended effect, such as to converge substantially simultaneously at a particular region or location in the room. For example, the speaker units 305 may be synchronized to produce acoustic signals which converge substantially simultaneously on the location of the audio source device 310, or the location of a user having a tracking device 315, such as a smartwatch or smartphone. Accordingly, performance of the audio system is improved.

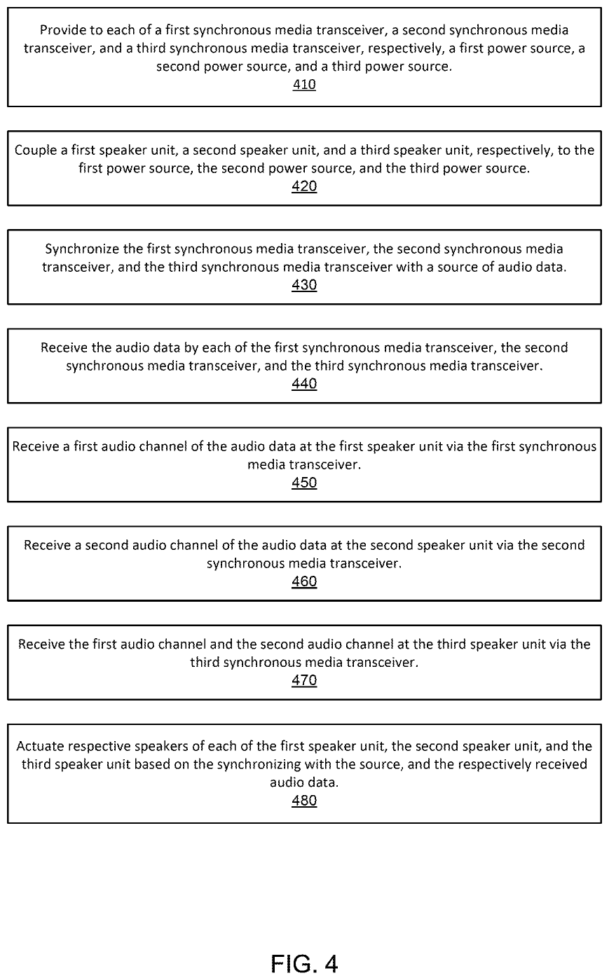

FIG. 4 is a flow diagram of a method of managing an audio system. At step 410, a first power source, a second power source, and a third power source a provided to each of a first synchronous media transceiver, a second synchronous media transceiver, and a third synchronous media transceiver, respectively. For example, a rechargeable battery source or mains power supply. At step 420, a first speaker unit, a second speaker unit, and a third speaker unit are coupled to the first power source, the second power source, and the third power source, respectively. At step 430, the first synchronous media transceiver, the second synchronous media transceiver, and the third synchronous media transceiver are synchronized with a source of audio data. For example, the source of audio data may be a smartphone or audio transceiver. Further, the synchronous media transceivers may be synchronized to produce acoustic signals substantially simultaneously or may be synchronized to produce acoustic signals to produce an intended effect, such as to be received substantially simultaneously in a particular region or at a particular point. For example, the synchronous media transceivers may be synchronized to produce acoustic signals which converge substantially simultaneously on the location of the source of audio data or another tracking device.

At step 440, audio data is received by each of the first synchronous media transceiver, the second synchronous media transceiver, and the third synchronous media transceiver, for example, from the source of audio data. At step 450, a first audio channel of the audio data is received at the first speaker unit via the first synchronous media transceiver. At step 460, a second audio channel of the audio data is received at the second speaker unit via the second synchronous media transceiver. At step 470, the first audio channel and the second audio channel are received at the third speaker unit via the third synchronous media transceiver. At step 480, respective speakers of each of the first speaker unit, the second speaker unit, and the third speaker unit are actuated based on the synchronizing with the source, and the respectively received audio data.

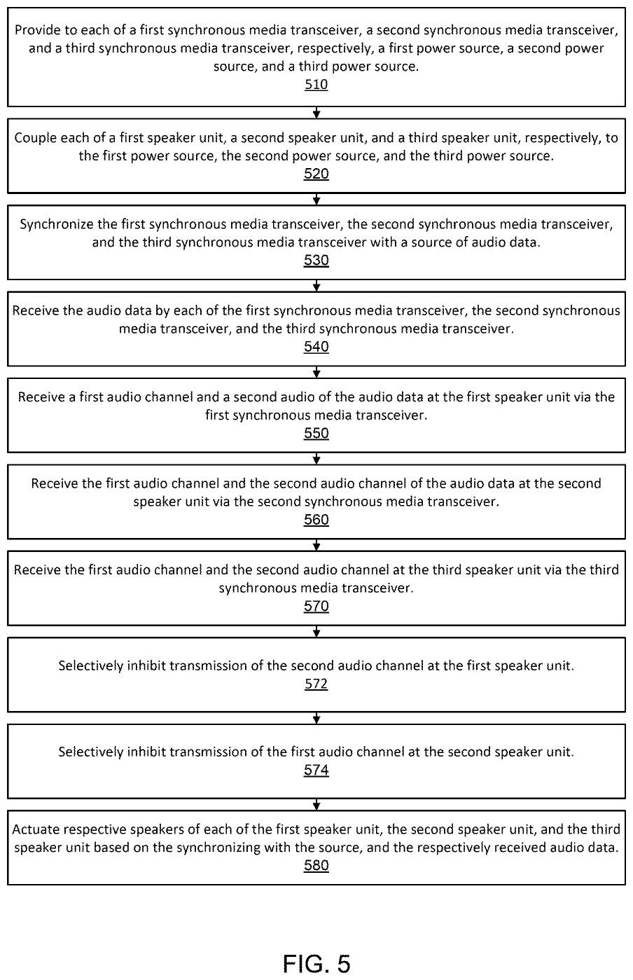

FIG. 5 is a flow diagram of a method of managing an audio system. At step 510, a first power source, a second power source, and a third power source a provided to each of a first synchronous media transceiver, a second synchronous media transceiver, and a third synchronous media transceiver, respectively. For example, a rechargeable battery source or mains power supply. At step 520, a first speaker unit, a second speaker unit, and a third speaker unit are coupled to the first power source, the second power source, and the third power source, respectively. At step 530, the first synchronous media transceiver, the second synchronous media transceiver, and the third synchronous media transceiver are synchronized with a source of audio data. For example, the source of audio data may be a smartphone or audio transceiver. Further, the synchronous media transceivers may be synchronized to produce acoustic signals substantially simultaneously or may be synchronized to produce acoustic signals to produce an intended effect, such as to be received substantially simultaneously in a particular region or at a particular point. For example, the synchronous media transceivers may be synchronized to produce acoustic signals which converge substantially simultaneously on the location of the source of audio data or another tracking device.

At step 540, audio data is received by each of the first synchronous media transceiver, the second synchronous media transceiver, and the third synchronous media transceiver, for example, from the source of audio data. At step 550, a first audio channel and a second audio channel of the audio data is received at the first speaker unit via the first synchronous media transceiver. At step 560, the first audio channel and the second audio channel of the audio data is received at the second speaker unit via the second synchronous media transceiver. At step 570, the first audio channel and the second audio channel are received at the third speaker unit via the third synchronous media transceiver. At step 572, transmission of the second audio channel is selectively inhibited at the first speaker unit. At step 574, transmission of the first audio channel is selectively inhibited at the second speaker unit. For example the first speaker unit and second speaker unit may employ dedicated circuitry, such as one or more dump resistors, to attenuate, mute, or otherwise inhibit the respective audio channels from being passed on to a speaker. At step 580, respective speakers of each of the first speaker unit, the second speaker unit, and the third speaker unit are actuated based on the synchronizing with the source, and the respectively received audio data.

Thus, the disclosure provides, among other things, an audio system and various methods of managing audio systems. Various features and advantages of the disclosure are set forth in the following claims.

What is claimed is:

1. An audio system comprising:
a first power source;
a first synchronous media transceiver configured to receive audio data;
a first speaker unit, configured to
receive power from the first power source,
receive a first audio channel of the audio data from the first synchronous media transceiver, and
actuate a speaker to convert the first audio channel into a corresponding acoustic signal;
a second power source;
a second synchronous media transceiver configured to receive the audio data;
a second speaker unit, configured to
receive power from the second power source,
receive a second audio channel from the second synchronous media transceiver, and
actuate a speaker to convert the second audio channel into a corresponding acoustic signal;
a third power source;
a third synchronous media transceiver configured to receive the audio data;
a third speaker unit, configured to
receive power from the third power source,
receive the first audio channel and the second audio channel of the audio data from the third synchronous media transceiver, and
actuate a speaker to convert the first audio channel and the second audio channel into a corresponding acoustic signal; and
wherein the first power source, the second power source, and the third power source are independent power sources.

2. The audio system of claim 1, wherein the first speaker unit, the second speaker unit, and the third speaker unit each include a full-range driver.

3. The audio system of claim 1, wherein each of the first, second, and third synchronous media transceivers are configured to wirelessly receive the audio data.

4. The audio system of claim 1, wherein at least one of the first power source, the second power source, and the third power source comprises a battery.

5. The audio system of claim 1, wherein
the first speaker unit is further configured to
receive the second audio channel of the audio data from the first synchronous media transceiver, and
selectively inhibit actuation of the speaker to prevent conversion of the second audio channel of the audio data into a corresponding acoustic signal; and
the second speaker unit is further configured to
receive the first audio channel of the audio data from the second synchronous media transceiver, and
selectively inhibit actuation of the speaker to prevent conversion of the first audio channel of the audio data into a corresponding acoustic signal.

6. The audio system of claim 5, wherein
the first speaker unit includes an electronic circuit for selectively inhibiting the second audio channel, and wherein
the second speaker unit includes an electronic circuit for selectively inhibiting the first audio channel.

7. The audio system of claim 1, wherein the first power source, the first synchronous media transceiver, and the first speaker unit are retained in a common housing.

8. A method of managing a speaker system, comprising:
providing to each of a first synchronous media transceiver, a second synchronous media transceiver, and a third synchronous media transceiver, respectively, a first power source, a second power source, and a third power source;
coupling each of a first speaker unit, a second speaker unit, and a third speaker unit, respectively, to the first power source, the second power source, and the third power source;
synchronizing the first synchronous media transceiver, the second synchronous media transceiver, and the third synchronous media transceiver with a source of audio data;
receiving the audio data by each of the first synchronous media transceiver, the second synchronous media transceiver, and the third synchronous media transceiver;
receiving a first audio channel of the audio data at the first speaker unit via the first synchronous media transceiver;
receiving a second audio channel of the audio data at the second speaker unit via the second synchronous media transceiver;
receiving the first audio channel and the second audio channel at the third speaker unit via the third synchronous media transceiver;
actuating respective speakers of each of the first speaker unit, the second speaker unit, and the third speaker unit based on the synchronizing with the source, and the respectively received audio data.

9. The method of managing a speaker system of claim 8, wherein the first speaker unit, the second speaker unit, and the third speaker unit each include a full-range driver.

10. The method of managing a speaker system of claim 8, where each of the first, second, and third synchronous media transceivers are configured to wirelessly receive the audio data.

11. The method of managing a speaker system of claim 8, wherein at least one of the first power source, the second power source, and the third power source comprises a battery.

12. The method of managing a speaker system of claim 8, further comprising:
receiving the second audio channel of the audio data at the first speaker unit via the first synchronous media transceiver;
receiving the first audio channel of the audio data at the second speaker unit via the second synchronous media transceiver;
selectively inhibiting transmission of the second audio channel at the first speaker unit; and
selectively inhibiting transmission of the first audio channel at the second speaker unit.

13. The method of managing a speaker system of claim 12, wherein at least one of the selectively inhibiting the first audio channel and selectively inhibiting the second audio channel comprises selectively inhibiting with a dedicated electronic circuit.

14. The method of managing a speaker system of claim 8, wherein the first power source, the first synchronous media transceiver, and the first speaker unit are retained in a common housing.

15. An audio system, comprising:
a first speaker unit, including
a first housing,
a first power source retained in the first housing,
a first synchronous media transceiver configured to receive audio data including a first audio channel and a second audio channel, the first synchronous media transceiver retained in the first housing,
a first speaker retained in the first housing, and
electronic control circuitry,
wherein the electronic control circuitry of the first speaker unit is configured to
receive power from the first power source,
receive the audio data from the first synchronous media transceiver,
selectively inhibit the second audio channel, and
actuate the first speaker to convert the first audio channel into a corresponding acoustic signal;
a second speaker unit, including
a second housing,
a second power source retained in the second housing,
a second synchronous media transceiver configured to receive audio data including the first audio channel and the second audio channel, the second synchronous media transceiver retained in the second housing,
a second speaker retained in the second housing, and
electronic control circuitry,
wherein the electronic control circuitry of the second speaker unit is configured to
receive power from the second power source,
receive the second audio channel of the audio data from the second synchronous media transceiver,
selectively inhibit the first audio channel, and
actuate the second speaker to convert the second audio channel into a corresponding acoustic signal; and
a third speaker unit, including
a third housing,
a third synchronous media transceiver configured to receive audio data including the first audio channel and the second audio channel, the third synchronous media transceiver retained in the third housing,
a third speaker retained in the third housing, and
electronic control circuitry,
wherein the electronic control circuitry of the third speaker unit is configured to
receive power from a third power source,
receive the first audio channel and the second audio channel of the audio data from the third synchronous media transceiver, and
actuate the third speaker to convert the first audio channel and the second audio channel into a corresponding acoustic signal,
wherein the first power source, the second power source, and the third power source are independent power sources.

16. The audio system of claim 15, wherein the first speaker unit, the second speaker unit, and the third speaker unit each include a full-range driver.

17. The audio system of claim 15, wherein each of the first, second, and third synchronous media transceivers are configured to wirelessly receive the audio data.

18. The audio system of claim 15, wherein at least one of the first power source, the second power source, and the third power source comprises a battery.

19. The audio system of claim 15, wherein the electronic control circuitry of the first speaker unit and the electronic circuitry of the second speaker unit each include resistive circuitry for selectively inhibiting an audio channel.
The audio system of claim 15, further comprising a fourth speaker unit.
